(19) United States
(12) Patent Application Publication
(10) Pub. No.: US 2025/0362414 A1
(43) Pub. Date: Nov. 27, 2025

(54) APPARATUS AND METHOD FOR GLOBAL NAVIGATION SATELLITE SYSTEM (GNSS) DOPPLER COMPENSATION

(71) Applicant: Airoha Technology Corp., Hsinchu (TW)

(72) Inventor: Yu-Wei LEE, Hsinchu County (TW)

(73) Assignee: Airoha Technology Corp., Hsinchu (TW)

(21) Appl. No.: 18/673,912

(22) Filed: May 24, 2024

(51) Int. Cl. G01S 19/25; G01S 19/29

(52) U.S. Cl. CPC G01S 19/254; G01S 19/29

(57) ABSTRACT

The disclosure proposes an apparatus and a method for Global Navigation Satellite System (GNSS) Doppler compensation. A complex multiplication is generated based on a first sample and a second sample, where the first sample is a delayed sample. A Doppler frequency is generated based on the complex multiplication. The Doppler frequency is output to a component of a GNSS receiver to remove Doppler effect from a received GNSS signal.

### BACKGROUND

The disclosure generally relates to global positioning system and, more particularly, to an apparatus and a method for Global Navigation Satellite System (GNSS) doppler compensation.

Due to the increasing demand of navigation and positioning applications in commercial devices, automobiles, boats, aircrafts, consumer electronics devices or other mobile objects are widely equipped with GNSS receivers. GNSSs are radio-communication infrastructures which enables a generic application to compute position, velocity and time at its current location, anywhere on the Earth or in the air, and processes the signals transmitted from a constellation of satellites, taken as references points. GNSS signals arrive at ground-based receiver antenna with a low power level. A generic GNSS signal, as obtained by a GNSS receiver, is affected by a nonnegligible Doppler frequency, due to the relative motion between any object on the Earth or in the air and satellites. The estimation of this frequency is one of the major signal processing tasks of a GNSS receiver.

### SUMMARY

In an aspect of the present invention, an embodiment discloses an apparatus for Global Navigation Satellite System (GNSS) Doppler compensation. The apparatus includes: a sample delay circuitry; a complex multiplier coupled to the correlator and the sample delay circuitry; and a frequency estimator coupled to the complex multiplier. The sample delay circuitry is arranged operably to delay an output of each sample for a time period of a repeating pattern, which is generated by a correlator, where the repeating pattern is periodically sent by a space vehicle. The complex conjugate transformer is arranged operably to perform a complex conjugate operation on a complex of a first sample output from the sample delay circuitry to generate a complex conjugate of the first sample. The complex multiplier is arranged operably to calculate a complex multiplication based on a first sample output from the sample delay circuitry and a second sample output from the correlator. The frequency estimator is arranged operably to generate a Doppler frequency based on the complex multiplication, and output the Doppler frequency to a component of the apparatus for removing a Doppler effect from a received GNSS signal.

In another aspect of the present invention, an embodiment discloses a method for GNSS Doppler compensation. The method, performed by a GNSS receiver, includes: generating a complex multiplication based on a first sample and a second sample, wherein the first sample is a delayed sample; generating a Doppler frequency based on the complex multiplication; and outputting the Doppler frequency to a component of the GNSS receiver to remove a Doppler effect from a received GNSS signal.

Both the foregoing general description and the following detailed description are examples and explanatory only, and are not restrictive of the invention as claimed.

### BRIEF DESCRIPTION OF THE DRAWINGS

FIG. 1 is a schematic diagram of positioning by an electronic device applying a global navigation satellite system (GNSS) according to an embodiment of the present invention.

FIG. 2 is a block diagram of a GNSS receiver according to an embodiment of the present invention.

FIG. 3 is a block diagram showing a Phase-Lock Loop (PLL) architecture installed in a baseband processor for compensating Doppler effect according to an embodiment of the present invention.

FIG. 4 is a block diagram showing a fine estimation architecture installed in a baseband processor for compensating Doppler effect according to an embodiment of the present invention.

FIG. 5 is a schematic diagram showing periodically appeared secondary code symbols according to an embodiment of the invention.

FIGS. 6-8 are block diagrams showing fine estimation architectures installed in a baseband processor for compensating Doppler effect according to embodiments of the present invention.

FIG. 9 is a flowchart illustrating a method for GNSS Doppler compensation according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

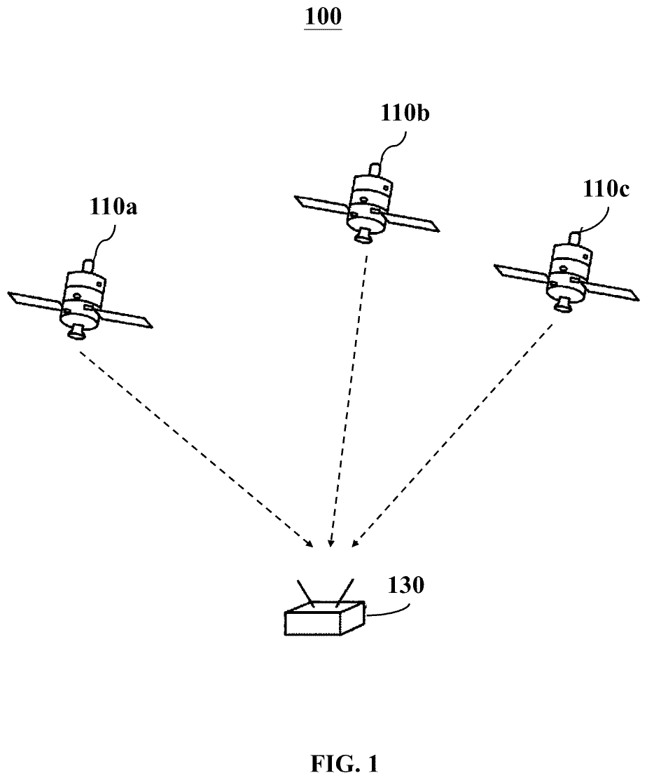

Refer to FIG. 1. An exemplary Global Navigation Satellite System (GNSS) 100 is illustrated, in which the electronic device 130 can determine current positions using wireless techniques. The GNSS 100 is radio communications infrastructure, which enables a generic application to compute position, velocity and time at its current location, anywhere on the Earth or in the air, and processes the signals transmitted from space vehicles (SVs, also referred to as satellite constellations) 110a, 110b, 110c, and so on, taken as references points. The GNSS signal is a radio wave transmitted from the SV 110a, 110b, 110c, or others. Nowadays, four global systems are operational: Global Positioning System (GPS), Global Navigation Satellite System (GLONASS), BeiDou, and Galileo. Regional navigation satellite systems in use are Quasi-Zenith Satellite System (QZSS), and the Indian Regional Navigation Satellite System (IRNSS). All these systems spread their message modulated with a higher rated Pseudo-Random Noise (PRN) code, which is then modulated with a Binary Phase Shift Keying (BPSK), or other modulation and transmitted over Radio Frequency (RF). Although the GNSS system is constructed by many SVs, the PRN code is unique to each SV. Identifying the PRN code carried in the received GNSS signal is synonymous with identifying the SV corresponding to the received GNSS signal. In some embodiments, the PRN code is referred to as the PRN sequence. The International Telecommunications Union (ITU) coordinates the shared global use of the radio spectrum. The exemplary GNSS constellations, bands and frequencies are listed in Table 1:

TABLE 1

| | | Frequency in MHz | | | |
|---|---|---|---|---|---|
| Constel- | | | Band- | | |
| lations | Bands | Centre | width | Lower | Upper |
| GPS | L1 (i.e., | 1575.42 | ±2 | 1573.42 | 1577.42 |
| | L1 with | | ±1.023 | 1574.397 | 1576.443 |
| | C/A code) | | ±10.23 | 1565.19 | 1585.65 |
| | | | ±15 | 1560 | 1590 |
| | L2 | 1227.60 | ±10.23 | 1217.37 | 1237.83 |
| | | | ±1.023 | 1226.577 | 1228.623 |
| | | | ±15 | 1212 | 1242 |
| | L5 | 1176.45 | ±10.23 | 1166.22 | 1186.68 |
| Galileo | E1 | 1575.42 | ±12.276 | 1563.144 | 1587.696 |
| | E5a | 1176.45 | ±10.23 | 1166.22 | 1186.68 |
| | E5(altBOC) | 1191.795 | ±25.575 | 1166.22 | 1217.37 |
| | E5b | 1207.14 | ±10.23 | 1196.91 | 1217.37 |
| | E6 | 1278.75 | ±20.46 | 1258.29 | 1299.21 |
| GLONASS | G1 | N/A | | 1598.0625 | 1605.37 |
| | | | ±0.5 | | |
| | | | ±5.0 | | |
| | G1a CDMA | 1600.995 | ±5.0 | 1595.995 | 1605.995 |
| | | | ±1 | 1599.995 | 1601.995 |
| | | | ±2 | 1598.995 | 1602.995 |
| | G2 | N/A | | 1242.9375 | 1248.625 |
| | | | ±0.5 | | |
| | | | ±5.0 | | |
| | G2a CDMA | 1248.06 | ±7.0 | 1241.06 | 1255.06 |
| | | | ±1 | 1247.06 | 1249.06 |
| | | | ±2 | 1246.06 | 1250.06 |
| | G3 CDMA | 1202.025 | ±10.23 | 1191.795 | 1212.255 |
| BeiDou | B11 | 1561.098 | ±2.046 | 1559.052 | 1563.144 |
| | B1 | 1575.42 | ±16.368 | 1559.052 | 1591.788 |
| | B2a | 1176.45 | ±10.23 | 1166.22 | 1186.68 |
| | B2/B2b | 1207.14 | ±10.0 | 1197 | 1217 |
| | B3l | 1268.52 | ±10.23 | 1258.29 | 1278.75 |

Taking GPS as an example, each of the SVs 110a, 110b and 110c transmits a GNSS signal called L1 signal (1575.42 MHz) as a positioning signal. L1 signals include satellite orbit information and navigation messages, which include time information based on the satellite's high precision clock and phase-modulated with a PRN code composed of 1023 chips at a chip rate of 1.023 MHz/chip with a period of 1 millisecond (ms). Each SV 110a, 110b or 110c repeatedly transmits a frame, which is a basic unit of navigation messages. It takes 30 seconds to send one frame. Each frame is divided into five subframes and is constituted as a bit string of 300 bits, which includes the satellite orbit information and the navigation messages. Each frame is transmitted by the SV 110a, 110b or 110c at a rate of 50 bits per second for 6 seconds. In each subframe, the PRN code with a period of 1 ms is repeated 20 times, and the phase of the PRN code is inverted if there is a bit switch.

The electronic device 130 may be installed in an automobile, a boat, an aircraft, a consumer electronics device or others. The electronic device 130 has a stand-alone GNSS receiver to acquire ephemeris data, an almanac, a reference time, and other measurements used to compute a location, thus to have satellite wireless positioning capabilities. In some embodiments, the electronic device 130 incorporating with the geographic information system (GIS) to display moving maps and information about location, speed, direction, nearby streets, etc. The Doppler effect (also referred to as the Doppler shift) occurs due to the relative motion between the electronic device 130 on the Earth or in the air and the SV 110a, 110b or 110c. The Doppler effect refers to a phenomenon in which the frequency of a wave shifts due to its relative movement with respect to the SV 110a, 110b or 110c. From the perspective of the GNSS receiver, the frequency of the received GNSS signal is increased when the SV 110a, 110b or 110c approaches the GNSS receiver. On the other hand, the frequency of the received GNSS signal is decreased when the SV 110a, 110b or 110c moves away from the GNS receiver.

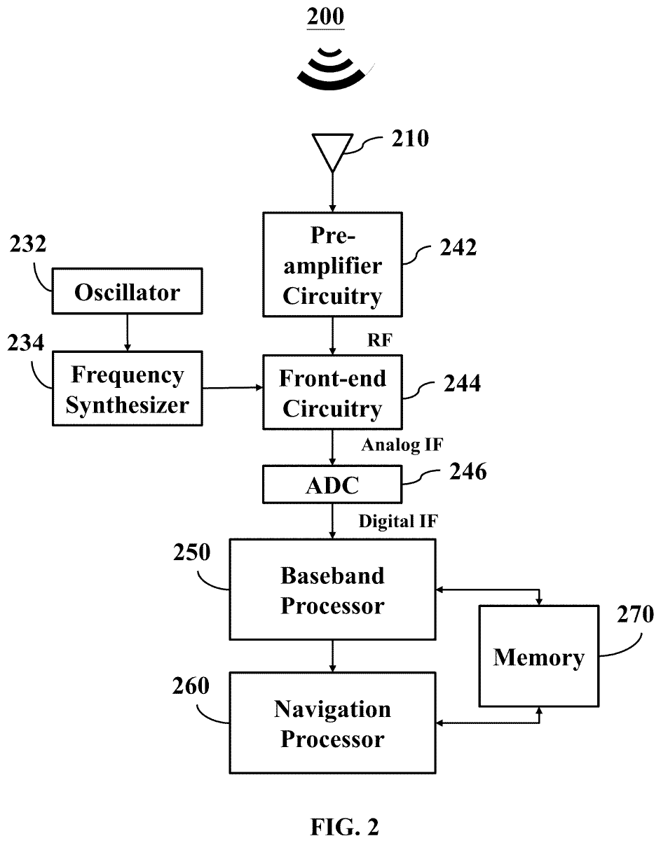

Refer to FIG. 2 showing the block diagram of the GNSS receiver 200 according to an embodiment of the present invention. The GNSS receiver 200 includes the antenna 210, the oscillator 232, the frequency synthesizer 234, the pre-amplifier circuitry 242, the front-end circuitry 244, the analog-to-digital converter (ADC) 246, the baseband processor 250, the navigation processor 260 and the memory 270.

The oscillator 232 generates a signal of a predetermined frequency by oscillating an oscillator made of, for example, crystal, and outputs the generated signal to the frequency synthesizer 234. The frequency synthesizer 234 generates a clock signal of a predetermined frequency (clock frequency) based on the signal output from the oscillator 232, and outputs the generated clock signal to the front-end circuitry 244.

Following the antenna 210, the pre-amplifier circuitry 242 sets the noise figure for the entire receiver system and may include a Low-Noise Amplifier (LNA) to amplify a low-power GNSS signal received by the antenna 210, and outputs the amplified GNSS signal to the front-end circuitry 244.

The front-end circuitry 244 involves filtering, amplification and downconverter. Given the low power of the received GNSS signal, out-of-band interference is suppressed using cutoff filters, may be accomplished by Surface Acoustic Wave (SAW) device. The amplification in multibit receivers may employ some form of automatic gain control (AGC). The downconverter converts the frequency of the GNSS signal to an intermediate frequencies (IF) that is a frequency division ratio multiple of the clock frequency, and outputs the GNSS signal at the IF to the ADC 246. The downconverter is performed in single or multiple stages. Multistage architectures allow for adequate image suppression and general bandpass filtering with the final IFs close to the baseband processor 250. The image suppression in the single-stage downconverter may be achieved by accepting a higher IF. The downconverter includes a carrier Voltage Controlled Oscillator (VCO) and a mixer. The mixer mixes the GNSS signal acquired from the pre-amplifier circuitry 242 and the output from the carrier VCO controlled to match a phase of the clock frequency with the mixer. The final conversion to baseband involves converting the IF signal to the in-phase (I) and quadrature (Q) components of the signal envelop. It is accomplished by mixing the IF signal with two tones generated at the final nominal IF but with one tone lagging the other in phase by π/2 radians. The output of the mixer may be the baseband components plus Doppler frequency.

The ADC 246 converts the GNSS signal at the IF into digital data, and outputs the digital data corresponding to the GNSS signal at the IF to the baseband processor 250. The single-bit or the multibit architecture may be used in the ADC 246.

In some embodiments, the baseband processor 250 includes dedicated hardware (such as carrier Numerically Controlled Oscillator (NCO), correlators, accumulators, etc.,) and a Digital Signal Processors (DSP). In alternative embodiments, the baseband processor 250 is implemented in a Graphics Processing Unit (GPU).

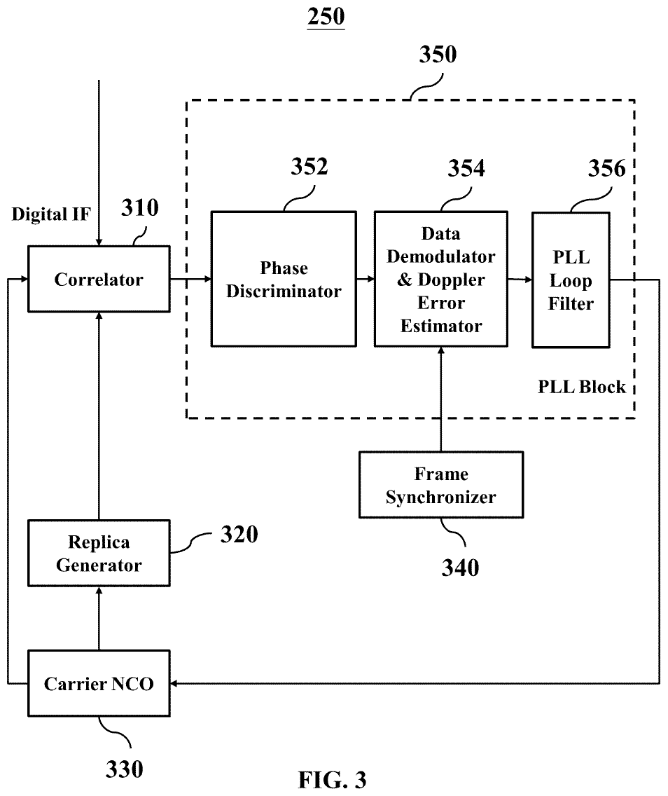

In some implementations, refer to FIG. 3 showing the block diagram of a Phase-Lock Loop (PLL) architecture installed in the baseband processor 250 for compensating Doppler effect. The baseband processor 250 includes the correlator 310, the replica generator 320, the carrier NCO 330, the frame synchronizer 340 and the PLL block 350. The PLL block 350 includes the phase discriminator 352, the data demodulator and Doppler error estimator 354 and the PLL loop filter 356 to track the phase of incoming GSS signals from the correlator 310 and provide a correction of the phase in a continuous loop, so that the Doppler frequency is output from the PLL loop filter 356 to the carrier NCO 330. However, with such architecture, the frame structure of navigation data should be known, and the Doppler effect compensation does not activate until the frame synchronizer 340 successfully decodes a specific frame carried in the received GNSS signal. It would need much time to complete the Doppler estimation, for example, longer than 2.5 seconds. Moreover, the performance of the PLL architecture would be dramatically degraded in case of a weak GNSS signal (for example, lower than −160 dBm), or is severely affected by multipath interferences (for example, surrounded by many high-rise buildings, beside a river, a lake or a seashore, or similar situations).

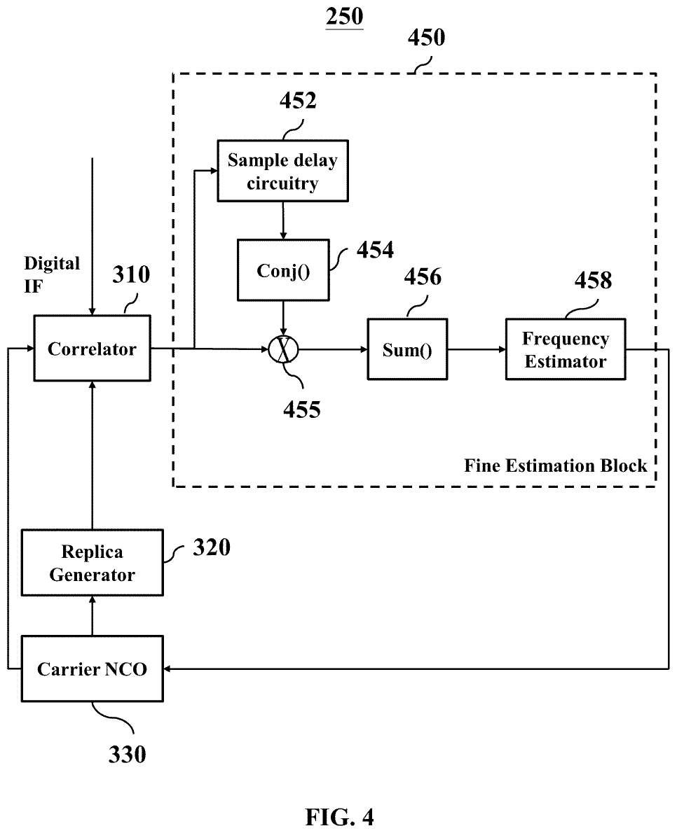

To improve the performance of the PLL architecture as shown in FIG. 3, an embodiment of the present invention proposes a fine estimation architecture. Refer to FIG. 4 showing the block diagram of the fine estimation architecture installed in the baseband processor 250 for compensating Doppler effect. The baseband processor 250 includes the correlator 310, the replica generator 320, the carrier NCO 330 and the fine estimation block 450.

The carrier NCO 330 produces I and Q data streams. The correlator 310 correlates the digital data received from the ADC 246 with a copy of the PRN code generated by the replica generator 320 and outputs a complex with the maximum peak per time unit (such as 1 or 2 ms). The correlator 310, the replica generator 320, the carrier NCO 330 and the fine estimation block 450 are arranged in the baseband processor 250 to form a feedback loop for compensating Doppler effect. The feedback loop is employed to ensure the output (e.g. I and Q data streams) of the carrier NCO 330 matches the phase of the received GNSS signal. The feedback loop is also employed to ensure the output (e.g. the copy of the PRN code) of the replica generator 320 matches the time period of the PRN code carried in the received GNSS signal.

The fine estimation block 450 includes the sample delay circuitry 452, the complex conjugate transformer 454, the complex multiplier 455, the summarizer 456 and the frequency estimator 458. Any of the complex conjugate transformer 454, the summarizer 456 and the frequency estimator 458 may be realized by digital logical gates, or program code that is loaded and executed by an application specific integrated circuits (ASIC), a DSP, a general-purpose processor, a field programmable logic array (FPGA), a GPU, or others.

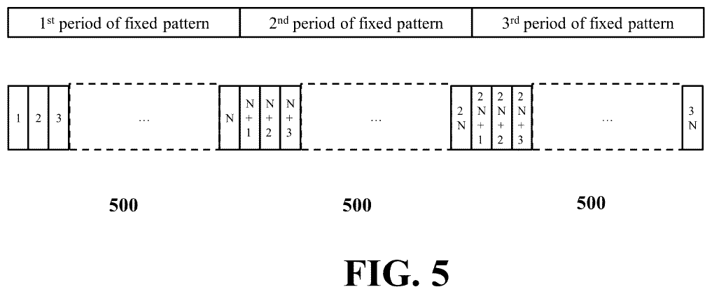

If there is a repeating pattern (e.g. secondary code symbol, Neuman-Hofman code symbol, etc.) periodically appeared in the received digital data from the ADC 246, the repeating pattern can be used to estimate Doppler effect. For example, the repeating pattern is the secondary code composed of 25 bits and the length of each bit is 4 ms. Refer to FIG. 5, the secondary code symbol 500 is repeated every 100 (N=100) ms. The sample delay circuitry 452 delays an output of each sample to the complex conjugate transformer 454 for the time period of the repeating pattern, and each sample is generated by the correlator 310. The sample delay circuitry 452 may be implemented in registers, a FIFO buffer, or others, to store samples that are output from the correlator 310 in one time period of repeating pattern. Taking the secondary code as an exemplary repeating pattern, the sample delay circuitry 452 stores 100 samples in chronological order. At each ms, the oldest sample is output from the “tail” component of the sample delay circuitry 452 to the complex conjugate transformer 454. Meanwhile, each subsequent sample shifts forward in the queue within the sample delay circuitry 452, and a new sample output from the correlator 310 is input to the “head” component of the sample delay circuitry 452.

The complex conjugate transformer 454 performs the complex conjugate operation on a complex of a sample output from the sample delay circuitry 452 to generate a complex conjugate. The complex multiplier 455 multiplies the complex of the sample output from the correlator 310, and the complex conjugate output from the complex conjugate transformer 454, and outputs the calculation result to the summarizer 456. Refer to FIG. 5, for example, the complex of the (N+1)^{th} sample is complex multiplied by the complex conjugate of the 1^{st} sample, the complex of the (N+2)^{th} sample is complex multiplied by the complex conjugate of the 2^{nd} sample, and so on, wherein N is a positive integer. The (N+i)^{th} sample occurs one time period of the repeating pattern after the i^{th} sample. Note that, since any two adjacent repeating patterns are sent in a relative short time period (for example 200 ms or shorter) sequentially, the conditions of multipath interference are substantially the same for the complex of i^{th} sample and the complex of the (N+i)^{th} sample generated by the correlator 310, where i is a positive integer ranging from 1 to N. Therefore, the variance between complexes of any two adjacent repeating patterns would be good basis to estimate Doppler frequency, without considering the complicated multipath interference.

The summarizer 456 accumulates L results output from the complex multiplier 455, where L is a positive integer and can be configured by the navigation processor 260. The accumulation by the summarizer 456 is expressed by the following equation:

$$Z = {\sum }_{k = 1}^{L} {{r}_{k} ( {r}_{k - N} )}^{*} \qquad Equation ( 1 )$$

where Z represents the output of the summarizer 456, rₖ represents the complex of the k^{th} sample, N represents a total number of samples generated in one time period of repeating pattern and (r_{k-N})* represents the complex conjugate of the (k−N)^{th} sample. The summarizer 456 outputs the accumulation results to the frequency estimator 458.

The frequency estimator 458 generates the Doppler frequency by the following equation:

$${\hat{f}}_{Δ} = - \frac{1}{2 π {NT}_{s}} arg ( Z ) \qquad Equation ( 2 )$$

where \hat{f}_{Δ} represents the Doppler frequency, N represents a total number of samples generated in one time period of repeating pattern, Tₛ represents the time period of one sample, Z represents the output of the summarizer 456 and arg( ) represents the arc tangent function. The Doppler frequency is output to the carrier NCO 330, so that the carrier NCO 330 removes the Doppler effect from the output I and Q data streams. Further, since the carrier NCO 330 outputs the adjusted clock waveform to the replica generator 320, the replica generator 320 adjusts the time period of the copy of the PRN code by taking the Doppler effect into account.

In alternative embodiments of the fine estimation block 450 as shown in FIG. 4, the summarizer 456 and the frequency estimator 458 are modified. The modified summarizer calculates the average of the accumulated L results output from the complex multiplier 455, where L is a positive integer and can be configured by the navigation processor 260. The average of accumulation results by the modified summarizer is expressed by the following equation:

$$Z a v g = {\sum }_{k = 1}^{L} {{r}_{k} ( {r}_{k - N} )}^{*} / L \qquad Equation ( 3 )$$

where Zavg represents the output of the modified summarizer, rₖ represents the complex of the k^{th} sample, N represents a total number of samples generated in one time period of repeating pattern and (r_{k-N})* represents the complex conjugate of the (k−N)^{th} sample. The modified summarizer outputs the average of accumulation results to the modified frequency estimator. The modified frequency estimator generates the Doppler frequency by the following equation:

$${\hat{f}}_{Δ} = - \frac{1}{2 π {NT}_{s}} arg ( Zavg ) \qquad Equation ( 4 )$$

where \hat{f}_{Δ} represents the Doppler frequency, N represents a total number of samples generated in one time period of repeating pattern, Tₛ represents the time period of one sample, Zavg represents the output of the modified summarizer and arg( ) represents the arc tangent function. In addition to the compensation for the Doppler effect, the modified frequency estimator further cancels noise signals.

In alternative embodiments of the fine estimation block 450 as shown in FIG. 4, the summarizer 456 is removed from the fine estimation block 450 and the frequency estimator 458 is modified. The modified frequency estimator obtains the calculation result (i.e. the phase difference) from the complex multiplier 455 and the frequency estimator 458 generates the Doppler frequency by the following equation:

$${\hat{f}}_{Δ} = - \frac{1}{2 π {NT}_{s}} arg ( d ) \qquad Equation ( 5 )$$

where \hat{f}_{Δ} represents the Doppler frequency, N represents a total number of samples generated in one time period of repeating pattern, Tₛ represents the time period of one sample, d represents the output of the complex multiplier 455 and arg( ) represents the arc tangent function.

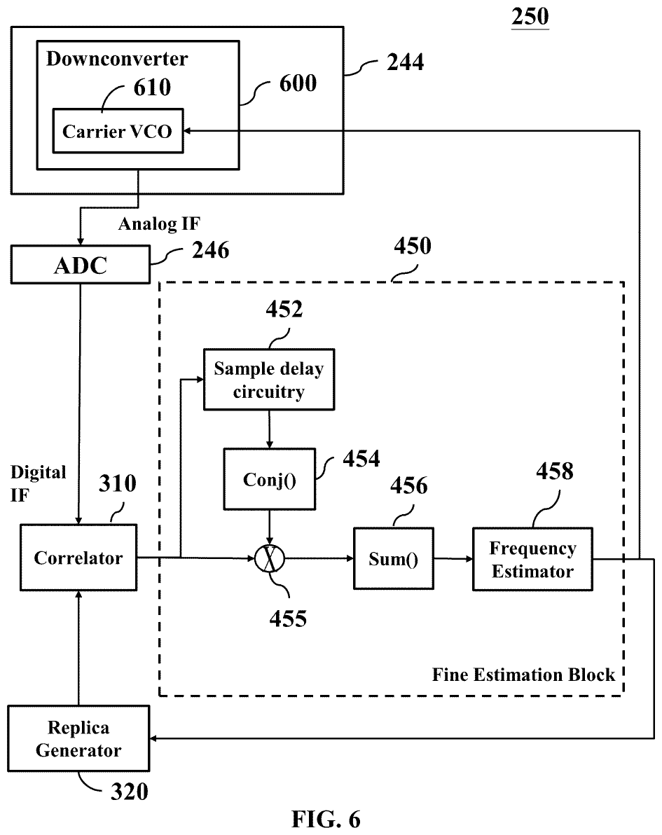

In alternative embodiment of the present invention, refer to FIG. 6 showing the block diagram of the fine estimation architecture installed in the baseband processor 250 for compensating Doppler effect. The fine estimation architecture shown in FIG. 6 is similar to that shown in FIG. 4 except that, for example, the fine estimation architecture shown in FIG. 6 includes the front-end circuitry 244. The front-end circuitry 244 includes the downconverter 600 and the downconverter 600 includes the carrier VCO 610. Unlike the compensation to the carrier NCO 330 as shown in FIG. 4, the Doppler frequency is output from the frequency estimator 458 to the carrier VCO 610, so that the carrier VCO 610 removes the Doppler effect from the GNSS signal at the IF. The Doppler frequency is also output from the frequency estimator 458 to a carrier NCO of the replica generator 320, so that the replica generator 320 adjusts the time period of the copy of the PRN code in accordance with the Doppler frequency.

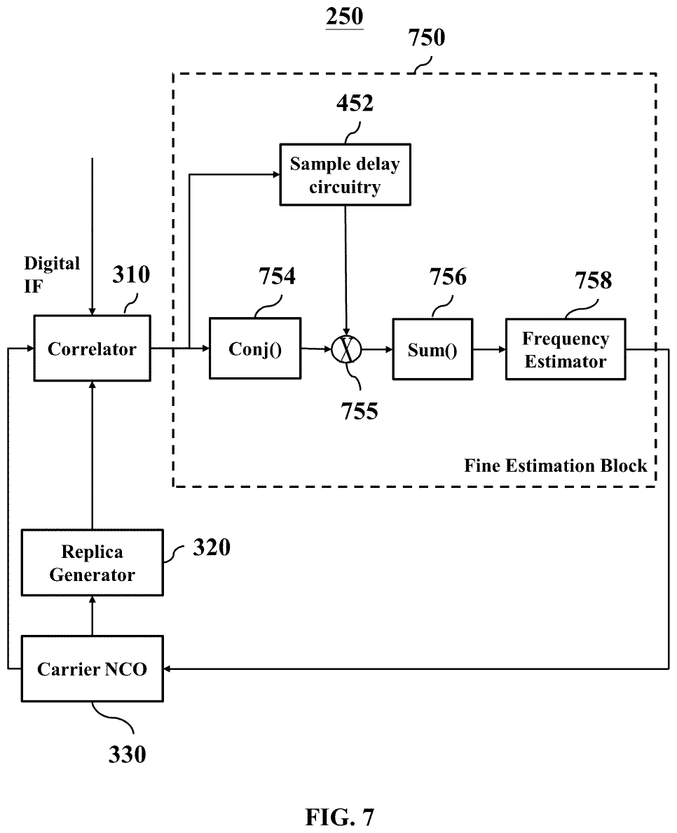

In alternative embodiment of the present invention, refer to FIG. 7 showing the block diagram of the fine estimation architecture installed in the baseband processor 250 for compensating Doppler effect. The baseband processor 250 includes the correlator 310, the replica generator 320, the carrier NCO 330 and the fine estimation block 750.

The fine estimation block 750 includes the sample delay circuitry 452, the complex conjugate transformer 754, the complex multiplier 755, the summarizer 756 and the frequency estimator 758. Any of the complex conjugate transformer 754, the summarizer 756 and the frequency estimator 758 may be realized by digital logical gates, or program code that is loaded and executed by an ASIC, a DSP, a general-purpose processor, a FPGA, a GPU, or others.

The complex conjugate transformer 754 performs the complex conjugate operation on a complex of a sample output from the correlator 310 to generate a complex conjugate. The sample delay circuitry 452 is modified to delay an output of each sample to the complex multiplier 755 for the time period of the repeating pattern, and each sample is generated by the correlator 310. The complex multiplier 755 multiplies the complex of the sample output from the sample delay circuitry 452, which was generated by the correlator 310 at a time point before one time period of the repeating pattern, and the complex conjugates output from the complex conjugate transformer 754, and outputs the calculation result to the summarizer 756.

The summarizer 756 accumulates L results output from the complex multiplier 755, where L is a positive integer and can be configured by the navigation processor 260. The accumulation by the summarizer 756 is expressed by the following equation:

$$Z = {\sum }_{k = 1}^{L} ( {r}_{k - N} ) {r}_{k}^{*} \qquad Equation ( 6 )$$

where Z represents the output of the summarizer 756, r_{k-N} represents the complex of the (k−N)^{th} sample, N represents a total number of samples generated in one time period of repeating pattern and rₖ* represents the complex conjugate of the k^{th} sample. The summarizer 756 outputs the accumulation results to the frequency estimator 758.

The frequency estimator 758 generates the Doppler frequency by the following equation:

$${\hat{f}}_{Δ} = \frac{1}{2 π {NT}_{s}} arg ( Z ) \qquad Equation ( 7 )$$

where \hat{f}_{Δ} represents the Doppler frequency, N represents a total number of samples generated in one time period of repeating pattern, Tₛ represents the time period of one sample, Z represents the output of the summarizer 456 and arg( ) represents the arc tangent function. The Doppler frequency is output to the carrier NCO 330, so that the carrier NCO 330 removes the Doppler effect from the output I and Q data streams. Further, since the carrier NCO 330 outputs the adjusted clock waveform to the replica generator 320, the replica generator 320 adjusts the time period of the copy of the PRN code by taking the Doppler effect into account.

In alternative embodiments of the fine estimation block 750 as shown in FIG. 7, the summarizer 756 and the frequency estimator 758 are modified. The modified summarizer calculates the average of the accumulated L results output from the complex multiplier 755, where L is a positive integer and can be configured by the navigation processor 260. The average of accumulation results by the modified summarizer is expressed by the following equation:

$$Zavg = {\sum }_{k = 1}^{L} ( {r}_{k - N} ) {r}_{k}^{*} / L \qquad Equation ( 8 )$$

where Zavg represents the output of the modified summarizer, r_{k-N} represents the complex of the (k−N)^{th} sample, N represents a total number of samples generated in one time period of repeating pattern and rₖ* represents the complex conjugate of the k^{th} sample. The modified summarizer outputs the average of accumulation results to the modified frequency estimator. The modified frequency estimator generates the Doppler frequency by the following equation:

$${\hat{f}}_{Δ} = \frac{1}{2 π {NT}_{s}} arg ( Zavg ) \qquad Equation ( 9 )$$

where \hat{f}_{Δ} represents the Doppler frequency, N represents a total number of samples generated in one time period of repeating pattern, Tₛ represents the time period of one sample, Zavg represents the output of the modified summarizer and arg( ) represents the arc tangent function. In addition to the compensation for the Doppler effect, the modified frequency estimator further cancels noise signals.

In alternative embodiments of the fine estimation block 750 as shown in FIG. 7, the summarizer 756 is removed from the fine estimation block 750 and the frequency estimator 758 is modified. The modified frequency estimator obtains the calculation result (i.e. the phase difference) from the complex multiplier 755 and the frequency estimator 758 generates the Doppler frequency by the following equation:

$${\hat{f}}_{Δ} = \frac{1}{2 π {NT}_{s}} arg ( d ) \qquad Equation ( 10 )$$

where \hat{f}_{Δ} represents the Doppler frequency, N represents a total number of samples generated in one time period of repeating pattern, Tₛ represents the time period of one sample, d represents the output of the complex multiplier 755 and arg( ) represents the arc tangent function.

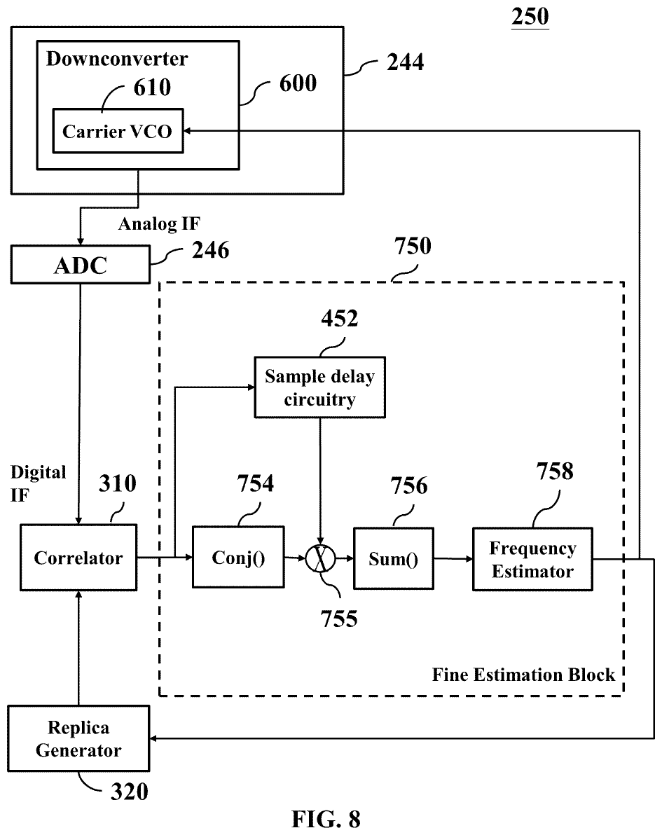

In alternative embodiment of the present invention, refer to FIG. 8 showing the block diagram of the fine estimation architecture installed in the baseband processor 250 for compensating Doppler effect. The fine estimation architecture shown in FIG. 8 is similar to that shown in FIG. 7 except that, for example, the fine estimation architecture shown in FIG. 8 includes the front-end circuitry 244. The front-end circuitry 244 includes the downconverter 600 and the downconverter 600 includes the carrier VCO 610. Unlike the compensation to the carrier NCO 330 as shown in FIG. 7, the Doppler frequency is output from the frequency estimator 758 to the carrier VCO 610, so that the carrier VCO 610 removes the Doppler effect from the GNSS signal at the IF. The Doppler frequency is also output from the frequency estimator 758 to a carrier NCO of the replica generator 320, so that the replica generator 320 adjusts the time period of the copy of the PRN code in accordance with the Doppler frequency.

Referring back to FIG. 2, the baseband processor 250 includes demodulation circuitries to acquire a navigation message carried in the digital data at IF derived from the received GNSS signal and outputs the acquired messages to the navigation processor 260. The navigation processor 260 may be implemented in numerous ways, such as with general-purpose hardware (e.g., a microcontroller unit—MCU, a single processor, a multi-core processor, a GPU, or others) that is programmed using firmware and/or software instructions to perform the specific functions. The navigation processor 260 calculates a current position of the electronic device 130 by performing a well-known positioning algorithm according to the navigation messages obtained from the SVs 110, 110b, 110c and the like, and other supplementary information (e.g. including a channel propagation delay).

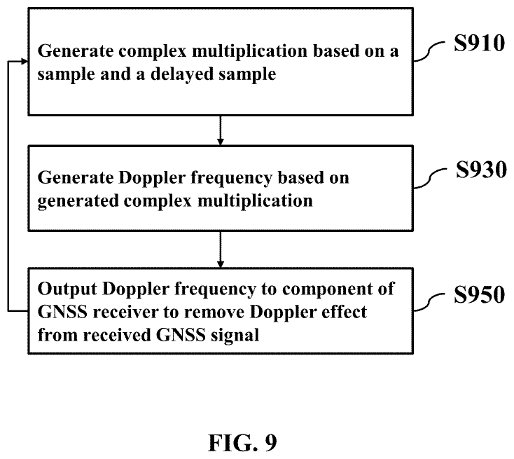

Refer to FIG. 9 illustrating a method for GNSS Doppler compensation, performed by the GNSS receiver 200 (specifically, the fine estimation block 450 or 750 of the baseband processor 250). A loop is repeatedly performed to track the Doppler effect and accordingly control a component in the GNSS receiver 200 to remove the Doppler effect from the received GNSS signal. The details are as follows:

Step S910: A complex multiplication is generated based on a sample and a delayed sample.

In some embodiments, as shown in FIG. 4 or 6, the complex multiplication of the complex of the (N+i)^{th} sample output from the correlator 310 by the complex conjugate of the i^{th} sample output from the sample delay circuitry 452 is generated by the complex multiplier 455.

In alternative embodiments, as shown in FIG. 7 or 8, a complex multiplication of the complex of the i^{th} sample output from the sample delay circuitry 452 by the complex conjugate of the (N+i)^{th} sample output from the correlator 310 is generated by the complex multiplier 755.

The complex of the i^{th} sample and the complex of the (N+i)^{th} sample generated by the correlator 310 are complexes with the maximum peaks at the i^{th} and the (N+i)^{th} time units, respectively.

Step S930: A Doppler frequency is generated based on the complex multiplication generated in step S910.

In some embodiments, the Doppler frequency is generated by the frequency estimator 458 using the equation (5) as described above.

In alternative embodiments, the Doppler frequency is generated by using the equations (1) and (2) as described above. Specifically, results output from the complex multiplier 455 are accumulated by the summarizer 456 using the equation (1) and the Doppler frequency is generated according to the accumulated results by the frequency estimator 458 using the equation (2).

In alternative embodiments, the Doppler frequency is generated by using the equations (3) and (4) as described above. Specifically, an average of accumulated results output from the complex multiplier 455 is calculated by the summarizer 456 using the equation (3) and the Doppler frequency is generated according to the average of the accumulated results by the frequency estimator 458 using the equation (4).

In alternative embodiments, the Doppler frequency is generated by the frequency estimator 758 using the equation (10) as described above.

In alternative embodiments, the Doppler frequency is generated by using the equations (6) and (7) as described above. Specifically, results output from the complex multiplier 755 are accumulated by the summarizer 756 using the equation (6) and the Doppler frequency is generated according to the accumulated results by the frequency estimator 758 using the equation (7).

In alternative embodiments, the Doppler frequency is generated by using the equations (8) and (9) as described above. Specifically, an average of accumulated results output from the complex multiplier 755 is calculated by the summarizer 756 using the equation (8) and the Doppler frequency is generated according to the average of the accumulated results by the frequency estimator 758 using the equation (9).

Step S950: The Doppler frequency is output to a component in the GNSS receiver 200 to remove the Doppler effect from the received GNSS signal. In some embodiments, the Doppler frequency is output to the carrier NCO 330 in the digital domain, as shown in FIG. 4 or 7, to perform the Doppler compensation. In alternative embodiments, the Doppler frequency is output to the carrier VCO 610 in the analog domain and the replica generator 320 in the digital domain, as shown in FIG. 6 or 8, to perform the Doppler compensation.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one electronic device, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as DSP code, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more microcontroller units (MCUs), digital signal processors (DSPs), general-purpose processors, application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 2, 4, and 6-8, it should be noted that additional elements may be included to achieve better performance without departing from the spirit of the invention. Each element of FIGS. 2, 4, and 6-8 is composed of various circuitries and arranged to operably perform the aforementioned operations. While the process flows described in FIG. 9 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for Global Navigation Satellite System (GNSS) Doppler compensation, comprising:
a sample delay circuitry, arranged operably to delay an output of each sample for a time period of a repeating pattern, which is generated by a correlator, wherein the repeating pattern is periodically sent by a space vehicle;
a complex multiplier, coupled to the correlator and the sample delay circuitry, arranged operably to calculate a complex multiplication based on a first sample output from the sample delay circuitry and a second sample output from the correlator; and
a frequency estimator, coupled to the complex multiplier, arranged operably to generate a Doppler frequency based on the complex multiplication, and output the Doppler frequency to a component of the apparatus for removing a Doppler effect from a received GNSS signal.

2. The apparatus of claim 1, wherein a start time of the second sample is one time period of the repeating pattern later than a start time of the first sample.

3. The apparatus of claim 2, wherein the repeating pattern is a secondary code symbol or a Neuman-Hofman code symbol.

4. The apparatus of claim 1, wherein the sample delay circuitry, the complex multiplier and the frequency estimator are arranged in a baseband processor.

5. The apparatus of claim 1, wherein the correlator correlates digital data received from an analog-to-digital converter with a copy of a Pseudo-Random Noise (PRN) code and outputs a complex with a maximum peak per time unit as a sample to the sample delay circuitry and the complex multiplier.

6. The apparatus of claim 1, wherein, for removing the Doppler effect from the received GNSS signal, the Doppler frequency is output to a carrier Numerically Controlled Oscillator (NCO) in a digital domain of the apparatus, and an adjusted clock waveform is output from the carrier NCO to a replica generator in the digital domain of the apparatus.

7. The apparatus of claim 1, wherein, for removing the Doppler effect from the received GNSS signal, the Doppler frequency is output to a carrier Voltage Controlled Oscillator (VCO) in an analog domain of the apparatus, and a carrier Numerically Controlled Oscillator (NCO) of a replica generator in a digital domain of the apparatus.

8. The apparatus of claim 1, further comprising:
a complex conjugate transformer, coupled to the sample delay circuitry, arranged operably to perform a complex conjugate operation on a complex of the first sample output from the sample delay circuitry to generate a complex conjugate of the first sample,
wherein the complex multiplier, coupled to the correlator and the complex conjugate transformer, arranged operably to complex multiply a complex of the second sample output from the correlator by the complex conjugate of the first sample to generate the complex multiplication.

9. The apparatus of claim 8, further comprising:
a summarizer, coupled to the complex multiplier, arranged operably to accumulate a plurality of first results output from the complex multiplier to generate a second result,
wherein the frequency estimator, coupled to the summarizer, arranged operably to generate the Doppler frequency according to the second result.

10. The apparatus of claim 9, wherein the summarizer generates the second result by an equation as follows:
$$Z = {\sum }_{k = 1}^{L} {{r}_{k} ( {r}_{k - N} )}^{*}$$
Z represents the second result, L represents a total number of the first results output from the complex multiplier, rₖ represents a complex of a k^{th} sample as the second sample, N represents a total number of samples generated in one time period of the repeating pattern, and (r_{k-N})* represents the complex conjugate of a (k−N)^{th} sample as the first sample,
wherein the frequency estimator generates the Doppler frequency by an equation as follows:
$${\hat{f}}_{Δ} = - \frac{1}{2 π {NT}_{s}} arg ( Z )$$
\hat{f}_{Δ} represents the Doppler frequency, N represents a total number of samples generated in one time period of the repeating pattern, Tₛ represents a time period of one sample, Z represents the second result, and arg( ) represents an arc tangent function.

11. The apparatus of claim 8, further comprising:
a summarizer, coupled to the complex multiplier, arranged operably to calculate an average of a plurality of first results output from the complex multiplier to generate a second result,
wherein the frequency estimator, coupled to the summarizer, arranged operably to generate the Doppler frequency according to the second result.

12. The apparatus of claim 11, wherein the summarizer generates the second result by an equation as follows:
$$Zavg = {\sum }_{k = 1}^{L} {{r}_{k} ( {r}_{k - N} )}^{*} / L$$
Zavg represents the second result, L represents a total number of the first results output from the complex multiplier, rₖ represents a complex of a k^{th} sample as the second sample, N represents a total number of samples generated in one time period of the repeating pattern, and (r_{k-N})* represents the complex conjugate of a (k−N)^{th} sample as the first sample,
wherein the frequency estimator generates the Doppler frequency by an equation as follows:
$${\hat{f}}_{Δ} = - \frac{1}{2 π {NT}_{s}} arg ( Zavg )$$
\hat{f}_{Δ} represents the Doppler frequency, N represents a total number of samples generated in one time period of the repeating pattern, Tₛ represents a time period of one sample, Zavg represents the second result, and arg( ) represents an arc tangent function.

13. The apparatus of claim 8, wherein the frequency estimator generates the Doppler frequency by an equation as follows:
$${\hat{f}}_{Δ} = - \frac{1}{2 π {NT}_{s}} arg ( d )$$
\hat{f}_{Δ} represents the Doppler frequency, N represents a total number of samples generated in one time period of the repeating pattern, Tₛ represents a time period of one sample, d represents the complex multiplication, and arg( ) represents an arc tangent function.

14. The apparatus of claim 1, further comprising:
a complex conjugate transformer, coupled to the correlator, arranged operably to perform a complex conjugate operation on a complex of the second sample output from the correlator to generate a complex conjugate of the second sample,
wherein the complex multiplier, coupled to the sample delay circuitry and the complex conjugate transformer, arranged operably to complex multiply a complex of the first sample output from the sample delay circuitry by the complex conjugate of the second sample to generate the complex multiplication.

15. The apparatus of claim 14, further comprising:
a summarizer, coupled to the complex multiplier, arranged operably to accumulate a plurality of first results output from the complex multiplier to generate a second result,
wherein the frequency estimator, coupled to the summarizer, arranged operably to generate the Doppler frequency according to the second result.

16. The apparatus of claim 15, wherein the summarizer generates the second result by an equation as follows:
$$Z = {\sum }_{k = 1}^{L} {r}_{k - N} {r}_{k}^{*}$$
Z represents the second result, L represents a total number of the first results output from the complex multiplier, r_{k-N} represents the complex of a (k−N)^{th} sample as the first sample, N represents a total number of samples generated in one time period of the repeating pattern, and rₖ* represents the complex conjugate of a k^{th} sample as the second sample,
wherein the frequency estimator generates the Doppler frequency by an equation as follows:
$$\hat{{f}_{Δ}} = \frac{1}{2 π N {T}_{s}} arg ( Z )$$
\hat{f}_{Δ} represents the Doppler frequency, N represents a total number of samples generated in one time period of the repeating pattern, Tₛ represents a time period of one sample, Z represents the second result, and arg( ) represents an arc tangent function.

17. The apparatus of claim 15, wherein the summarizer generates the second result by an equation as follows:
$$Z avg = {\sum }_{k = 1}^{L} {r}_{k - N} {r}_{k}^{*} / L$$
Zavg represents the second result, L represents a total number of the first results output from the complex multiplier, r_{k-N} represents the complex of a (k−N)^{th} sample as the first sample, N represents a total number of samples generated in one time period of the repeating pattern, and rₖ* represents the complex conjugate of a k^{th} sample as the second sample,
wherein the frequency estimator generates the Doppler frequency by an equation as follows:
$$\hat{{f}_{Δ}} = \frac{1}{2 π N {T}_{s}} arg ( Z a v g )$$
\hat{f}_{Δ} represents the Doppler frequency, N represents a total number of samples generated in one time period of the repeating pattern, Tₛ represents a time period of one sample, Zavg represents the second result, and arg( ) represents an arc tangent function.

18. The apparatus of claim 14, wherein the frequency estimator generates the Doppler frequency by an equation as follows:
$$\hat{{f}_{Δ}} = \frac{1}{2 π N {T}_{s}} arg ( d )$$
\hat{f}_{Δ} represents the Doppler frequency, N represents a total number of samples generated in one time period of the repeating pattern, Tₛ represents a time period of one sample, d represents the complex multiplication, and arg( ) represents an arc tangent function.

19. A method for Global Navigation Satellite System (GNSS) Doppler compensation, performed by a GNSS receiver, comprising:
generating a complex multiplication based on a first sample and a second sample, wherein the first sample is a delayed sample;
generating a Doppler frequency based on the complex multiplication; and
outputting the Doppler frequency to a component of the GNSS receiver to remove a Doppler effect from a received GNSS signal.

20. The method of claim 19, wherein a start time of the second sample is one time period of a fixed pattern later than a start time of the first sample.

21. The method of claim 20, wherein the repeating pattern is a secondary code symbol or a Neuman-Hofman code symbol.

22. The method of claim 20, wherein the method is performed by a baseband processor of the GNSS receiver.

23. The method of claim 19, wherein the first sample and the second sample are generated by a correlator, and the correlator correlates digital data received from an analog-to-digital converter with a copy of a Pseudo-Random Noise (PRN) code and outputs a complex with a maximum peak per time unit as a sample.

24. The method of claim 19, wherein, for removing the Doppler effect from the received GNSS signal, the Doppler frequency is output to a carrier Numerically Controlled Oscillator (NCO) in a digital domain of the GNSS receiver, and an adjusted clock waveform is output from the carrier NCO to a replica generator in the digital domain of the GNSS receiver.

25. The method of claim 19, wherein, for removing the Doppler effect from the received GNSS signal, the Doppler frequency is output to a carrier Voltage Controlled Oscillator (VCO) in an analog domain of the GNSS receiver, and a carrier Numerically Controlled Oscillator (NCO) of a replica generator in a digital domain of the GNSS receiver.

26. The method of claim 19, further comprising:
generating the complex multiplication by complex multiplying a complex of the second sample by a complex conjugate of the first sample.

27. The method of claim 26, wherein the Doppler frequency is generated by an equation as follows:
$$\hat{{f}_{Δ}} = \frac{1}{2 π N {T}_{s}} arg ( d )$$
\hat{f}_{Δ} represents the Doppler frequency, N represents a total number of samples generated in one time period of the repeating pattern, Tₛ represents a time period of one sample, d represents the complex multiplication, and arg( ) represents an arc tangent function.

28. The method of claim 26, comprising:
accumulating a plurality of first results to generate a second result by using an equation as follows:
$$Z = {\sum }_{k = 1}^{L} {{r}_{k} ( {r}_{k - N} )}^{*}$$
Z represents the second result, L represents a total number of the first results, rₖ represents a complex of a k^{th} sample as the second sample, N represents a total number of samples generated in one time period of a repeating pattern, and (r_{k-N})* represents a complex conjugate of a (k−N)^{th} sample as the first sample; and
generating the Doppler frequency according to the second result by an equation as follows:
$$\hat{{f}_{Δ}} = - \frac{1}{2 π N {T}_{s}} arg ( Z )$$
\hat{f}_{Δ} represents the Doppler frequency, N represents a total number of samples generated in one time period of the repeating pattern, Tₛ represents a time period of one sample, Z represents the second result, and arg( ) represents an arc tangent function.

29. The method of claim 26, comprising:
calculating an average of a plurality of first results to generate a second result by an equation as follows:
$$Zavg = {\sum }_{k = 1}^{L} {{r}_{k} ( {r}_{k - N} )}^{*} / L$$
Zavg represents the second result, L represents a total number of the first results, rₖ represents a complex of a k^{th} sample as the second sample, N represents a total number of samples generated in one time period of the repeating pattern, and (r_{k-N})* represents the complex conjugate of a (k−N)^{th} sample as the first sample; and
generating the Doppler frequency according to the second result by an equation as follows:
$$\hat{{f}_{Δ}} = - \frac{1}{2 π N {T}_{s}} arg ( Zavg )$$
\hat{f}_{Δ} represents the Doppler frequency, N represents a total number of samples generated in one time period of the repeating pattern, Tₛ represents a time period of one sample, Zavg represents the second result, and arg( ) represents an arc tangent function.

30. The method of claim 19, further comprising:
generating the complex multiplication by complex multiplying a complex of the first sample by a complex conjugate of the second sample.

31. The method of claim 30, wherein the Doppler frequency is generated by an equation as follows:
$$\hat{{f}_{Δ}} = \frac{1}{2 π N {T}_{s}} arg ( d )$$
\hat{f}_{Δ} represents the Doppler frequency, N represents a total number of samples generated in one time period of the repeating pattern, Tₛ represents a time period of one sample, d represents the complex multiplication, and arg( ) represents an arc tangent function.

32. The method of claim 30, comprising:
accumulating a plurality of first results to generate a second result by using an equation as follows:
$$Z = {\sum }_{k = 1}^{L} {r}_{k - N} {r}_{k}^{*}$$
Z represents the second result, L represents a total number of the first results output from the complex multiplier, r_{k-N} represents the complex of a (k−N)^{th} sample as the first sample, N represents a total number of samples generated in one time period of the repeating pattern, and rₖ* represents the complex conjugate of a k^{th} sample as the second sample,
generating the Doppler frequency according to the second result by an equation as follows:
$$\hat{{f}_{Δ}} = \frac{1}{2 π N {T}_{s}} arg ( Z )$$
\hat{f}_{Δ} represents the Doppler frequency, N represents a total number of samples generated in one time period of the repeating pattern, Tₛ represents a time period of one sample, Z represents the second result, and arg( ) represents an arc tangent function.

33. The method of claim 30, comprising:
calculating an average of a plurality of first results to generate a second result by an equation as follows:
$$Zavg = {\sum }_{k = 1}^{L} {r}_{k - N} {r}_{k}^{*} / L$$
Zavg represents the second result, L represents a total number of the first results output from the complex multiplier, r_{k-N} represents the complex of a (k−N)^{th} sample as the first sample, N represents a total number of samples generated in one time period of the repeating pattern, and rₖ* represents the complex conjugate of a k^{th} sample as the second sample, generating the Doppler frequency according to the second result by an equation as follows:
$$\hat{{f}_{Δ}} = \frac{1}{2 π N {T}_{s}} arg ( Zavg )$$
\hat{f}_{Δ} represents the Doppler frequency, N represents a total number of samples generated in one time period of the repeating pattern, Tₛ represents a time period of one sample, Zavg represents the second result, and arg( ) represents an arc tangent function.
